(19) United States
(12) Patent Application Publication
(10) Pub. No.: US 2008/0178769 A1
(43) Pub. Date: Jul. 31, 2008

(54) KIT AND METHOD FOR PREPARING A HARDENABLE CEMENTITIOUS COMPOSITION

(75) Inventors: Frederick R. GOODWIN, Solon, OH (US); Sandra R. Sprouts, Oakwood Village, OH (US)

Correspondence Address: CURATOLO SIDOTI CO., LPA, 24500 CENTER RIDGE ROAD, SUITE 280, CLEVELAND, OH, 44145, US

(73) Assignee: Construction Research & Technology GmbH, Trostberg (DE)

(21) Appl. No.: 12/020,994

(22) Filed: Jan. 28, 2008

Related U.S. Application Data
(60) Provisional application No. 60/898,251, filed on Jan. 30, 2007.

(51) Int. Cl. C04B 7/00; C04B 7/02; C04B 7/32; C04B 7/345; C04B 14/42; C04B 18/02; C04B 7/36; C04B 14/48; C04B 11/00; C04B 7/14; C04B 7/34

(52) U.S. Cl. 106/690; 106/638; 106/713; 106/692; 106/772; 106/789; 106/792; 524/2; 106/711; 106/802

(57) ABSTRACT

A kit for preparing a hardenable cementitious composition includes a pre-proportioned cementitious material component and at least one pre-formulated and pre-proportioned liquid additive component, wherein the cementitious material and liquid components are mixed with together to prepare a cementitious material that possesses end application properties. Also disclosed is a method for preparing a hardenable cementitious composition using the kit and a method for repairing a flas in a cementitious structure using the hardenable cementitious composition.

### CROSS REFERENCE TO RELATED APPLICATIONS

This application claims the benefit of the filing date under 35 U.S.C. §119(e) of U.S. Provisional Application For Patent Ser. No. 60/898,251, filed on Jan. 30, 2007, which is hereby incorporated by reference in its entirety.

### TECHNICAL FIELD

Provided are a kit and method for preparing a hardenable cementitious composition. The kit includes a universal cementitious material component that may be utilized with a variety of differently formulated liquid components, and at least one pre-proportioned and pre-formulated liquid component.

### BACKGROUND

Conventional cementitious compositions require differently formulated dry cementitious powder components to produce the required performance properties, such as different consistencies for different end application methods including low pressure spray-applied shotcrete, form and pour repairs, vertical repairs, overhead repairs, pumped materials, trowel-applied mortars, and the like. The number of differently formulated dry cementitious powder components required at any given job-site to achieve a variety of differently performing cementitious compositions for different end applications creates unnecessary mixing complexity and increased inventory of differently formulated dry cementitious materials. Additionally, with respect to the storage and on-site handling, typically the volume of bagged dry cementitious powder is approximately three times that of liquid components, and the weight of the dry cementitious powder is approximately five times that of liquid components.

Traditionally, the dry powder cementitious component is pre-formulated for a particular application, and the liquid component is either job site added water or multi-purpose liquid additives that are suitable for mixing with more than one type of differently formulated dry powder cementitious component. Using job-site measured water or liquid admixtures complicates the preparation of cementitious compositions, as this exercise requires the use of weighing devices, volumetric measurement devices, dilution of concentrated liquid components such as aqueous polymer dispersions, or judgmental estimations at the discretion of the individual mixing the material. Some conventional materials allow applicator adjustment of the mixing ratio of the dry powder and liquid components to produce different consistencies and performance for different end applications (i.e., “non-shrink” grouts used as dry-pack, plastic, flowable, and fluid consistencies).

Bagged cementitious powders for use with a liquid component are either formulated for a specific application, or in some situations the same liquid component is used with differently formulated bagged cementitious components for different applications.

Different mixing ratios of dry cementitious powder components to liquid admixture components produce differing physical properties, such as permeability, freeze thaw durability, strength, modulus, porosity, flowability sag resistance, and the like. Errors in mixing proportions can have catastrophic effects on the overall performance and durability of the resulting cementitious composition.

Accordingly, the use of a pre-proportioned universal dry cementitious material component in combination with different pre-proportioned and pre-formulated liquid additive components would be desirable to achieve more consistent performance and application properties of the resulting cementitious composition, while minimizing mixing complexity and reducing required inventory of bulky bags of differently formulated cementitious materials.

### SUMMARY

A kit and method for preparing a cementitious composition is provided, whereby the performance properties of a pre-formulated base cementitious material are determined by the use of a pre-formulated liquid additive that does not require further addition of water at a job-site. The pre-formulated liquid additive component does not need to be diluted at the job-site. The kit and method represent a completely reverse approach to traditional methods for preparing a cementitious composition, the traditional method using differently pre-formulated cementitious materials with a single universal liquid component or dilutions of this single universal liquid component.

Provided is a kit for preparing a hardenable cementitious composition having end application dictated performance characteristics comprising a pre-proportioned base cementitious material component that may be mixed with differently formulated liquid additives, and at least one pre-proportioned and pre-formulated liquid additive component, wherein said liquid additive imparts said performance characteristics.

Also provided is a method for preparing a hardenable cementitious composition having end application dictated performance characteristics, the method comprises mixing together a pre-proportioned base cementitious material component with a pre-formulated and pre-proportioned liquid component that imparts said end application dictated performance characteristics to said composition.

Additionally provided is a method for repairing a flaw in a cementitious structure, the method comprising mixing together a pre-proportioned base cementitious material component and a pre-formulated and pre-proportioned liquid additive component to form a hardenable cementitious repair composition having end application dictated performance characteristics imparted by said liquid component, and applying said cementitious repair composition to said flaw.

### DETAILED DESCRIPTION

Generally provided is a kit and method for preparing a cementitious composition having desired application performance properties. The kit includes a base cementitious material component and a liquid additive component. The application performance properties of the cementitious composition are determined by the combination of the universal base cementitious material component and the pre-proportioned and pre-formulated liquid additive component of the kit.

The base cementitious material component included in the kit and useful in the method for preparing a cementitious composition may be any known inorganic cementitious binder. Without limitation, suitable inorganic cementitious binders may include hydraulic cements. Hydraulic cements include materials that set and harden in the presence of water. Suitable non-limiting examples of hydraulic cements include Portland cement, modified Portland cement, masonry cement, alumina cement, refractory cement, calcium aluminate cement, calcium sulfoaluminate cement, calcium sulfate hemi-hydrate cement, oil well cement, ground granulated blast furnace slag, natural cement, hydraulic hydrated lime, and mixtures of these materials. Portland cement, as used in the trade, refers to a hydraulic cement that is produced by pulverizing clinker, comprised of hydraulic calcium silicates, calcium aluminates, and calcium ferroaluminates, with one or more of the forms of calcium sulfate and/or limestone as an interground addition. Portland cements according to ASTM C150 are classified as types I, II, III, IV, or V, and cements that are chemically similar or analogous to Portland cement, the specifications for which are set forth in ASTM specifications C 1157, C 595, and C 845. Magnesia cements, such as magnesium phosphate cements and magnesium potassium phosphate cements, may also be used as the base cementitious material.

The base cementitious material component may be packaged in any size convenient for processing, transportation, storage, mixing, and application. Without limitation, the base cementitious material component may be packaged in bags, wherein, for example, the bagged weight of the cementitious material is in the range from about 5 to about 95 lbs. According to other embodiments, the base cementitious material component may be packaged in bulk bags, wherein, for example, the bagged weight of the bulk cementitious material is in the range from about 500 to about 4000 lbs. The packaging size may be determined by the producer's packaging equipment (for example, bagging equipment capable of filling 40 to 60 lbs or bulk bags), the size of the pre-packaged liquid components, the transportation or storage limitations (for example, pallet size or pallet rack capacity), the mixing equipment used for combining the two components (for example, drill and pail, mortar mixer, mobile mixer, transit mixer), or to produce a yield of the mixed material convenient for estimation purposes (for example, ½ cubic ft, 1 cubic meter, etc.), or for repairs requiring smaller volumes of material than can be conveniently delivered using conventional ready mixed concrete.

In another embodiment, aggregates can be blended with the powder component and packaged in a size such that the liquid component achieves the proper consistency and water to cementitious ratio when mixed with the pre-extended powder/aggregate blend.

In another embodiment, aggregates can be blended with the powder component and packaged in the same weight or yield size as the unextended powder component such that a reduced quantity of the liquid component is used to achieve the proper consistency and water to cementitious ratio when mixed with the pre-extended powder/aggregate blend.

The cementitious fraction of the powder component may be optimized to develop certain strength as well as to provide sufficient binder to encapsulate aggregate particles to achieve a hardened cementitious material that is sufficiently strong and capable of proper consolidation.

In the context of a kit and method for the preparation of a cementitious material, the base cementitious material component and/or liquid components may or may not include aggregate. If no aggregate is contained in the cementitious material, then the resulting cementitious material comprises a cementitious paste. If only fine aggregate is used in the cementitious material, the resulting cementitious material comprises a mortar. If both fine and coarse aggregate are used in the cementitious material then the resulting cementitious material comprises a concrete. An example of a mixed paste or mortar mixture not containing coarse aggregate that results in a concrete once applied is preplaced aggregate concrete. An example of a paste not containing coarse or fine aggregate is a geotechnical cementitious grout for rock injection.

The aggregate top size of the fine aggregate that may be included in the base cementitious material component may be controlled by the limiting dimension of intended placement. Typically, this dimension may be limited to no less than 3 times or more than 20 times the diameter of the largest aggregate particle (i.e. if the depth of placement is ½″ then the aggregate top size would be ⅓ of ½″ to 1/20^{th} of ½″) and then subsequently graded to optimize particle packing or achieve other desired properties. Adjustments to the ideal packing gradation are commonly made based upon raw material availability or to enhance certain application properties, such as flowability or inclusion of light weight particles to reduce density. The aggregate content may be maximized to control cost, as well as provide the lowest shrinkage in the hardened cementitious material once other factors described below have been considered.

In addition to the inorganic cement binder component(s) of the base cementitious material, and aggregate additions, other any other known cement additives or admixtures may optionally be present. For example, without limitation, the optional ingredients may be selected from the classifications known to those familiar with the art, including but not limited to air entraining agents, air-detraining agents, shrinkage compensation agents, shrinkage reducing admixtures, dispersants such as superplasticizers, expansive agents, corrosion inhibitors, density modifiers, humectants, setting control agents (set retarders or set accelerators), foaming agents, defoaming agents, fillers, fibers, redispersible polymers, water soluble polymers, viscosity control agents, rheology modifying agents, wetting agents, water repellants, strength enhancing agents, colorants, dyes, pigments, pozzolans, and any other admixture or additive that does not adversely affect the properties of the cementitious composition. The inclusion and fraction of these ingredients may be determined based upon the desired mixing, plastic, and hardened properties of the mixed cementitious material and is typically expressed as a function of the cementitious content. Listed below are several non-limiting examples of admixtures and additives that can be used with the present invention.

The term air entrainer includes any chemical that will entrain air in cementitious compositions. Air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves a concrete's resistance to surface scaling caused by chemical deicers. Air entrainment also increases the workability of fresh concrete while eliminating or reducing segregation and bleeding. Materials used to achieve these desired effects can be selected from salts of wood resin; (Vinsol resin); some synthetic detergents; salts of sulfonated lignin; salts of petroleum acids; salts of proteinaceous material; fatty and resinous acids and their salts; alkylbenzene sulfonates; and salts of sulfonated hydrocarbons. Air entrainers are added in an amount to yield a desired level of air in a cementitious composition. The amount of air entrainers in a cementitious composition can vary widely due to variations in materials, mix proportion, temperature, and mixing action.

Retarding, or delayed-setting, admixtures are used to retard, delay, or slow the rate of setting of concrete. Retarders are used to offset the accelerating effect of hot weather on the setting of concrete, or delay the initial set of concrete or grout when difficult conditions of placement occur, or problems of delivery to the job site, or to allow time for special finishing processes or to aid in the reclamation of concrete left over at the end of the work day. Most retarders also act as water reducers and can also be used to entrain some air into concrete. Without limitation, lignosulfonates, hydroxylaled carboxylic acids, lignin, borax, gluconic, tartaric and other organic acids and their corresponding salts, phosphonates, certain carbohydrates and mixtures thereof can be used as retarding admixtures.

Air detrainers are used to decrease the air content in the mixture of concrete. Tributyl phosphate, dibutyl phthalate, octyl alcohol, water-insoluble esters of carbonic and boric acid, and silicones are some of the common materials that can be used to achieve this effect.

Alkali-reactivity reducers can reduce the alkali-aggregate reaction and limit the disruptive expansion forces in hardened concrete. Pozzolans (fly ash, silica flume), blast-furnace slag, salts of lithium and barium are especially effective.

Bonding admixtures are usually added to Portland cement mixtures to increase the bond strength between old and new concrete and include organic materials such as rubber, polyvinyl chloride, polyvinyl acetate, acrylics, styrene butadiene copolymers, and other powdered polymers.

Dispersant may also be included as a component of the kit. The term dispersant as used throughout this specification includes, among others, polycarboxylate dispersants, with or without polyether units. The term dispersant is also meant to include those chemicals that also function as a plasticizer, water reducers, high range water reducers, fluidizer, antiflocculating agent, or superplasticizer for cementitious compositions, such as lignosulfonates (calcium lignosulfonates, sodium lignosulfonates and the like), salts of sulfonated naphthalene sulfonate condensates, salts of sulfonated melamine sulfonate condensates, beta naphthalene sulfonates, sulfonated melamine formaldehyde condensates, naphthalene sulfonate formaldehyde condensate resins, for example, LOMAR D® dispersant (Cognis Inc., Cincinnati, Ohio), polyaspartates, oligomeric dispersants, any other chemical that functions as a dispersant or water reducer or superplasticizer for cement, and mixtures thereof.

The term polycarboxylate dispersant throughout this specification refers to polymers with a carbon backbone with pendant side chains, wherein at least a portion of the side chains are attached to the backbone through a carboxyl group or an ether group. Examples of polycarboxylate dispersants can be found in U.S. Ser. No. 09/369,562 filed on Aug. 6, 1999, U.S. Ser. No. 09/371,627 filed on Aug. 11, 1999, U.S. Ser. No. 09/212,652 filed on Dec. 16, 1998, European Patent Application Publication EP753488, U.S. Pat. No. 5,158,996, U.S. Pat. No. 6,008,275, U.S. Pat. No. 6,136,950, U.S. Ser. No. 09/592,231 filed on Jun. 9, 2000, U.S. Pat. No. 5,609,681, U.S. Pat. No. 5,494,516; U.S. Pat. No. 5,674,929, U.S. Pat. No. 5,660,626, U.S. Pat. No. 5,668,195. U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, and U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are incorporated herein by reference.

Natural and synthetic admixtures are used to color concrete for aesthetic and safety reasons. These coloring admixtures are usually composed of pigments and include carbon black, iron oxide, phthalocyanine, umber, chromium oxide, titanium oxide and cobalt blue.

Corrosion inhibitors in concrete serve to protect embedded reinforcing steel from corrosion due to its highly alkaline nature. The high alkaline nature of the concrete causes a passive and noncorroding protective oxide film to form on the steel. However, carbonation or the presence of chloride ions from deicers or seawater can destroy or penetrate the film and result in corrosion. Corrosion-inhibiting admixtures chemically arrest this corrosion reaction. The materials most commonly used to inhibit corrosion are calcium nitrite, sodium nitrite, sodium benzoate, certain phosphates or fluorosilicates, fluoroaluminates, amines, organic based water repelling agents, and related chemicals.

Dampproofing admixtures reduce the permeability of concrete that have low cement contents, high water-cement ratios, or a deficiency of fines in the aggregate. These admixtures retard moisture penetration into dry concrete and include certain soaps, stearates, and petroleum products.

Grouting agents, such as air-entraining admixtures, accelerators, retarders, and non-shrink and workability agents, adjust grout properties to achieve a desired result for specific applications. For example, Portland cement grouts are used for a variety of different purposes, each of which may require a different agent to stabilize foundations, set machine bases, fill cracks and joints in concrete work, cement oil wells, fill cores of masonry walls, and grout pre-stressing tendons and anchor bolts, and fill the voids in pre-placed aggregate concrete.

Gas formers, or gas-forming agents, are sometimes added to concrete and grout in very small quantities to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers.

Permeability reducers are used to reduce the rate at which water under pressure is transmitted through concrete. Silica fume, fly ash, ground slag, natural pozzolans, water reducers, and latex can be employed to decrease the permeability of the concrete. Pozzolan is a siliceous or siliceous and aluminous material, which in itself possesses little or no cementitious value. However, in finely divided form and in the presence of moisture, pozzolan will chemically react with calcium hydroxide at ordinary temperatures to form compounds possessing cementitious properties.

Pumping aids are added to concrete mixes to improve pumpability. These admixtures thicken the fluid concrete, i.e., increase its viscosity, to reduce de-watering of the paste while it is under pressure from the pump. Among the materials used as pumping aids in concrete are organic and synthetic polymers, hydroxyethylcellulose (HEC) or HEC blended with dispersants, organic flocculants, organic emulsions of paraffin, coal tar, asphalt, acrylics, bentonite and pyrogenic silicas, natural pozzolans, fly ash and hydrated lime.

Bacteria and fungal growth on or in hardened concrete may be partially controlled through the use of fungicidal, germicidal, and insecticidal admixtures. The most effective materials for these purposes are polyhalogenated phenols, dialdrin emulsions, and copper compounds.

The pre-formulated universal base cementitious powder component may include but is not limited to, ingredients that contribute to a cementitious composition having one or more of the following properties or characteristics, namely, placement depth or section thickness, sulphate resistance, alkali aggregate reaction resistance, impermeability, rheology suitable for proper consolidation, fiber reinforcement, shrinkage compensation, thixotropic properties, desired working and setting times, density control, rapid strength development, color matching, and combinations thereof.

According to certain embodiments, fine and/or coarse aggregate may be included in the kit for preparing a hardenable cementitious composition. The fine and/or coarse aggregate may be pre-blended into the powder cementitious component and at least one properly proportioned and formulated liquid component provided to achieve the desired characteristics of a cementitious composition, such as a mortar or concrete.

In another embodiment, the kit for preparing a cementitious material composition may optionally include a separate packaged aggregate in addition to the cementitious powder component. The fine and/or coarse aggregate may be provided in separate packages apart from the base cementitious material component of the kit. According to embodiments where the aggregate is provided in separate packages, the kit may include a package of a blend of fine and coarse aggregate, and/or separate packages of fine and coarse aggregate.

According to certain embodiments, the packaged aggregate addition may also include reinforcing fibers and/or other additives that are incompatible with mixing into the liquid additive component. One or more pre-packaged aggregate additions can optionally be used in combination with the liquid components and universal cementitious powder component described above. The aggregate additions may comprise blends of different, but suitable aggregates to achieve the desired gradation or other properties.

According to certain embodiments, fine sand may be pre-packaged and added separately to a paste cementitious component and used for the preparation of typical mortar applications. The fine sand aggregate may be packaged at the optimum proportion for addition to a fixed quantity of base paste cementitious material component.

According to other embodiments, pea gravel, such as without limitation ⅜″ pea gravel, can be pre-packaged and added separately to a mortar cementitious component and used for additional applications, for example, for placement of the resulting cementitious composition at greater depths or section thickness. The pea gravel may be pre-packaged at the optimum proportion for addition to a fixed quantity of base mortar cementitious material.

According to other embodiments, a pre-packaged coarse aggregate addition may be used in addition to the pea gravel for concrete replacement.

According to other embodiments, the coarse aggregate may be used separately from the pea gravel aggregate for preplaced aggregate concreting by using a self-consolidating liquid and base cementitious powder component kit.

Therefore, the kit for preparing a hardenable cementitious composition may eliminate job-site added materials and provide unitized ingredients. According to an illustrative embodiment, the kit includes a bag of powder cementitious material component containing either paste, mortar, or concrete aggregates, one package of liquid component, and optionally one bag fine aggregate, and optionally one bag ⅜″ pea gravel, and optionally one bag ¾″ aggregate, depending on the powder component composition and the intended cementitious material application.

As described above, the aggregate additions may also be blended with fibers. Fibers may be selected according to different types to serve different purposes. Generally, the fibers are relatively strong in tension compared to the hardening cementitious binder; therefore one benefit of fiber addition is to improve tensile properties of the cementitious composition through fiber bond with the cementitious matrix. The bonding of the fibers to the cementitious matrix is affected by the surface area of the fiber, the surface texture of the fiber, the amount of mechanical interlock between the fiber and the cementitious matrix, the chemical properties of the fiber and the cementitious matrix, the tensile elongation characteristics of the fiber, the elastic modulus of the fiber, and other factors.

Because the mixed material is inorganic cement based, the physical and chemical properties change as the material cures and ages. The early age strength is typically lower than the later age strength. Therefore, lower modulus fibers with satisfactory bonding characteristics are helpful for early age properties such as plastic shrinkage cracking control. Higher modulus fibers with satisfactory bonding characteristics to the cementitious matrix can distribute the tensile stresses from drying shrinkage or flexural strains to improve the hardened properties of the repair material. Additionally, known to those having skill in the art, some low melting point fibers can serve as ventilation channels to allow the escape of entrapped and combined water that can cause spalling when the cementitious matrix is exposed to high temperatures, such as are found in a fire. Fibers can also be helpful in distribution of impact type loads. Fibers also modify the rheology of the freshly mixed cementitious material causing a thickening action as well as improving the cohesiveness of the cementitious material, which may be a desirable property in some applications.

The fibers may be included in the kit by being included the base cementitious material component, in an aggregate component, or supplied as a separate package of fibers. Without limitation, suitable fibers that may be included in the kit include any natural, synthetic or combination of natural and synthetic fibers that impart the above described properties to the cementitious composition. Carbon, ceramic, glass, metal, metal alloy, or polymer fibers may be included in the kit for preparing a hardenable cementitious composition. Of course, it is also suitable that a combination of two or more the disclose fibers may be included in the kit.

The kit for preparing a cementitious composition includes at least one liquid additive component that is uniquely pre-formulated and pre-proportioned to provide desired performance properties for an intended application for the cementitious composition. Additional kits for other purposes are achieved by use of a different liquid additive component that is uniquely pre-formulated and pre-proportioned to provide the desired performance properties for alternative intended applications for the cementitious composition.

According to certain embodiments, the liquid additive components included in the kit are useful for preparing different types of cementitious material. Because different applications require different composition consistencies, the quantity of the liquid additive components for each application can be packaged in optimum amounts to produce an optimum consistency of the cementitious composition. Additionally, the additives contained within the formulated liquid component can be tailored to produce specific properties both within a freshly mixed cementitious material, as well as the hardened material. These specific cementitious material properties include but are not limited to rheology modification (i.e., through the use of well-known dispersants, superplasticizers, water-reducing admixtures and/or thickeners); modulus, impact, adhesion, and elongation characteristics of the hardened material (i.e., through the well-known use of polymer modifiers); permeability or porosity (i.e., through the use of different quantities of water or density modifying agents); working and setting times (i.e., through the use of different types and levels of well-known accelerating and retarding additives); and other known properties of mortar and hardened cementitious materials.

According to certain embodiments, the liquid component is mixed with the base cementitious powder component to create a resultant cementitious material having desired characteristics. Liquid components may include water, humectants, polymer dispersions (latex); rheology modifiers; setting-control agents; foaming additives; shrinkage-reducing admixtures; colorants, density modifiers, or any other additives or admixtures that are compatible with the binder system that are stable and compatible in the water based liquid additive component. Liquid component quantities are packaged in amounts compatible with a corresponding fixed quantity of the base cementitious powder component. The liquid component does not include job-site measured water. The liquid component composition can be selected based upon the desired rheology, setting time, density, color, or other properties of the resultant cementitious material. In certain embodiments, the base liquid component may include water, a polymer dispersion, defoamer, and setting-control additives.

According to certain embodiments, both the base cementitious material powder component and the liquid additive components are packaged for use in a fixed mixing proportion of 1:1, wherein the mixing ratio of 1:1 means that the total quantity of base cementitious powder component in a first package has been measured for its complete use with the entire quantity of a liquid component separately contained in a second package. This avoids the need to make job-site additions to the liquid component, or to measure out exact quantities of the dry cementitious and liquid additive components. The liquid and powder components require no dilution or other additions to provide optimum performance properties within a specified range of application properties.

Any suitable container known in the art may be used to package the dry cementitious component and the liquid additive component. Non-limiting examples of suitable containers include bags, jugs, bottles, flexible packaging, jars, cans, drums, barrels and combinations thereof. In certain embodiments, the containers used to package the base cementitious material component and the liquid additive component are non-reclosable so that their contents are used in their entirety at the time of mixing at the job-site, thus preventing the misproportioning of partially utilized containers. The container may be additionally constructed so as to be weather resistant.

According to illustrative embodiments, the kit for preparing a cementitious composition may include a cementitious powder component and two or more liquid additive components that are packaged in suitable-sized containers. By way of example, the kit may include a single powder component and at least two alternative liquid components in order to achieve different properties after the powder and either liquid component is mixed. The properties, such as the rheology, of a cementitious material that has been prepared using the kit is determined by the liquid component that was selected and mixed with the powder component. Depending on which liquid component is selected and mixed with the powder component, distinct cementitious materials having respectively distinct rheologies may be produced.

A method is provided for preparing a cementitious composition, such as a mortar, paste, or concrete, wherein the cementitious composition is prepared by mixing a universal cementitious powder component with pre-formulated and pre-proportioned liquid component. The method may include utilizing a kit, wherein the kit includes a single base cementitious powder component and at least two alternative liquid components in order to achieve different properties after the powder and either liquid component is mixed. The properties of a cementitious material prepared using the kit is determined by the liquid component that was selected and mixed with the powder component. For example, depending on which liquid component is selected and mixed with the powder component, distinct cementitious materials having respectively distinct rheologies may be produced.

One or more embodiments provide for increasing both the manufacturing and handling efficiency of various types of cementitious materials. Because powder components for cementitious materials are both heavy, resulting in more difficulty in handling and distribution, and bulky, requiring more storage space, using a kit having a single powder component, along with multiple interchangeable liquid components, results in a significant increase in convenience and efficiency. Therefore, a cementitious material produced from a single powder component, along with interchangeable liquid components that allow versatility in applications, and results in significant convenience for the user.

The base cementitious material powder and liquid components may be measured and packaged separately and bundled together to form a kit, or may be measured and packaged separately and placed in an overpack or other suitable container to form a kit containing both components. The latter provides the convenience of a single unit containing the components of the proper proportions of the liquid and powder components for consistent properties.

The base cementitious material powder and liquid components may be measured and packaged separately in non-reclosable containers. The non-reclosable containers promote an accurate mixing ratio for each required ingredient and provide ease of application and reliable properties with the mixed cementitious material. The non-reclosable nature of the packages minimizes the potential for adulteration of the components, as is common with dilution with conventional concentrated latex additives diluted on the job site to the proper solids content.

The term “kit” therefore encompasses situations where the separately packaged cementitious powder component and liquid component(s) are both contained within an overpack, or where the separately packaged cementitious powder component and liquid component(s) are maintained in separate packages and bundled together to form a kit, or where the separately packaged cementitious powder component and liquid component(s) are maintained in separate packages and simply sold together as a kit of components that are not contained within an overpack container or bundled together.

In general, the weight of the liquid additive component is approximately 20% of the powder component and the liquid uses about one-third of the storage space, which results in lower storage costs, ease of maintaining inventory, reduction in freight charges, ease of distribution, and versatile application characteristics.

The cementitious material is convenient to prepare and produces superior performance due to a fixed mixing ratio resulting in a constant water to cement ratio. Using a single powder component with interchangeable liquid components for different product performance or applications minimizes the number, complexity, volume, and weight of materials needed to be stored for a given construction application. Utilizing pre-proportioned powder and liquid components helps to produce cementitious materials with consistent performance and application properties.

A single “base powder” component mixed with an interchangeable liquid component may produce a cementitious material with a variety of performance properties and inventory advantages. These advantages can include:
Reducing inventory on the job-site and intermediate storage/distribution locations since the volume and weight of the liquid component is approximately ⅓ and ⅕ of the volume and weight of the powder component respectively, thereby reducing the storage space, storage costs, and freight charges.
Reducing the number of bagged materials required to produce different concrete repair applications such as a “form and pour” application requiring a self consolidating consistency or a “vertical and overhead” application requiring a non-sagging consistency, thereby increasing the ease of distribution and application versatility.
Customization and extension of the composition by introducing additional liquid components, such as adjusting the composition of the liquid component to more closely match the modulus of elasticity, permeability, or electrical conductivity of the original substrate or surrounding concrete with the repair material as described by ACR 546 R-04 section 1.4 and other industry references.
Manufacturing longer production runs of difficult-to-make bagged components and shorter production runs at multiple regionally based locations of relatively easier to make liquid components, thereby increasing manufacturing and distribution efficiencies.

Easier handling and improved application properties for contractors can also be achieved because using proportionally packaged bagged and liquid components leads to an optimized mixing ratio. The mixing instructions are simpler since the bagged and liquid components may be used at a 1:1 ratio by container (no weighing or volume measurements). The non-reclosable liquid-component packaging (i.e., pouches) provides more rapid temperature adjustment for improved product performance, as compared to the prior art of job-site-added ice or hot mixing water. The pouches can be completely immersed in a controlled temperature water bath or preconditioned and stored in insulated containers until mixed to provide precise temperature control of the mixture temperature, a desirable characteristic in inclement weather conditions.

The prior-art formulations for conventional two-component mortars typically required an inherently liquid component, initially thought to be a disadvantage due to the marketing efforts of “single-component” bagged products and redispersible polymer powder suppliers. These “single-component” bagged products are in reality still two-component materials requiring the addition of locally supplied mixing water than can be varied at the discretion of the applicator, thereby producing non-optimized performance results in the material when applied and after hardening. The mixing water used for “single-component” products must be supplied conveniently to the mixing location, whereby the kit and method eliminate this requirement.

The cementitious material kit having a powder component and at least two distinct types of liquid components, wherein upon mixing one of the at least two distinct types of liquid components with the powder component, a cementitious material results wherein the cementitious material rheology varies depending on which of the at least two distinct types of liquid components is mixed with the powder component. The powder component and the at least two distinct types of liquid components can be packaged for use in pre-measured fixed amounts. Furthermore, the powder component and each of the at least two distinct types of liquid components can be pre-measured into amounts of fixed proportions, wherein the powder component and one of the liquid components are proportioned to be mixed together in their entirety in creating a two component cementitious material packaged as a kit.

Another embodiment provides for a method for making a cementitious material of specific rheology, wherein the method includes providing a plurality of liquid components of a pre-measured amount to be used in combination with a powder component of a pre-measured amount, mixing the powder component of pre-measured amount in its entirety with one of the liquid components of pre-measured amount in its entirety in order to create a cementitious material having a specific desired rheology. The desired rheology varies depending on the required material application characteristics and which of the liquid components is mixed with the powder component.

The kit and method may be utilized to prepare a wide variety of cementitious compositions. Without limitation, the resulting cementitious composition may be used as cementitious binders, concretes, grouts, mortars, cementitious adhesives, cementitious fireproofing compositions, cementitious flooring compositions, self consolidating cementitious materials, screedable cementitious materials, trowel applied antifracture and watertight cementitious membranes, vertical/overhead cementitious materials, self-levelling repair cementitious material for form and pour, form and pump, and pre-placed aggregate concrete applications, as a hand applied or low-pressure spray applied vertical and overhead repair cementitious material, as a screedable re-sloping topping or levelling cementitious material for inclined or horizontal surfaces, as an underwater grouting material, as a flexible crack isolation or waterproofing membrane, and various other materials for grouting, tuck-pointing, constructing masonry assemblies, stuccoing, and the like by interchanging the liquid component and using the identical composition of the powder component.

The use of a fixed mixing ratio of pre-proportioned dry cementitious material and liquid additive components provides consistent and reliable performance properties of the resulting cementitious composition.

The use of a pre-formulated universal dry cementitious material component that may be mixed with a variety of differently pre-formulated liquid additives reduces freight and storage space, due to the versatility of usage for the base cementitious material component with the smaller packaged liquid component.

The use of a pre-formulated universal base cementitious material component that may be mixed with a variety of differently pre-formulated liquid additives may also be more convenient for applicators, as the applicator may use the universal base cementitious material component with different liquid additives for a number of different applications.

Different application methods and purposes can be more easily achieved due to reduced storage of a number of different bulky bagged cementitious materials, a componentized kit configuration, and flexibility of the cementitious material component usage.

### EXAMPLES

The following examples are intended to describe the kit and method for preparing a hardenable cementitious composition in greater detail. It should be noted that the examples are merely illustrative and are not to be construed as limiting the kit or method of using the kit in any manner

### Example 1

A screedable mortar composition was prepared using a two-component kit comprising separately packaged pre-proportioned cementitious powder and liquid additive components.

Powder Component: base mortar

| Liquid Component | % |
|---|---|
| Water | 92.30 |
| Glycol Ether | 7.70 |
| | 100.00 |

| Mix Parameters | Test Methods | Results |
|---|---|---|
| Base Mortar | | 1 kg |
| Liquid | | 0.13 kg |
| Flow @ 10 drops | ASTM C230 | 48 |
| Unit Wt. lbs/ft3 | ASTM C185 | 139.4 |
| Stiffening Rate, hrs:min | ASTM C266 | 00:41 |
| Initial Set, hrs:min | ASTM C266 | 00:51 |
| Final Set, hrs:min | ASTM C266 | 02:51 |
| 1 day Compressive str. psi | ASTM C109M | — |

### Example 2

A pigmented screedable mortar composition was prepared using a two-component kit comprising separately packaged pre-proportioned cementitious powder and liquid additive components.

Powder Component: base mortar

| Liquid Component | % |
|---|---|
| Water | 75.8 |
| Iron oxide pigment dispersion | 17.20 |
| Glycol Ether | 7.00 |
| | 100.00 |

| Mix Parameters | Test Methods | Results |
|---|---|---|
| Base Mortar | | 1 kg |
| Liquid | | 0.15 kg |
| Flow @ 10 drops | ASTM C230 | 58 |
| Unit Wt. lbs/ft3 | ASTM C185 | 139.4 |
| Stiffening Rate, hrs:min | ASTM C266 | 01:18 |
| Initial Set, hrs:min | ASTM C266 | — |
| Final Set, hrs:min | ASTM C266 | 04:09 |
| 1 day Compressive str. psi | ASTM C109M | 4650 |

### Example 3

A mortar composition useful for hand-trowel applied vertical and overhead applications was prepared using a two-component kit comprising separately packaged pre-proportioned cementitious powder and liquid additive components.

Powder Component: base mortar

| Liquid Component | % |
|---|---|
| Water | 92.73 |
| Modified clay | .20 |
| Modified cellulose ether | 0.07 |
| Glycol Ether | 7.00 |
| | 100.00 |

| Mix Parameters | Test Methods | Results |
|---|---|---|
| Base Mortar | | 1 kg |
| Liquid | | 0.145 kg |
| Flow @ 10 drops | ASTM C230 | 48 |
| Unit Wt. lbs/ft3 | ASTM C185 | 138.6 |
| Stiffening Rate, hrs:min | ASTM C266 | 00:33 |
| Initial Set, hrs:min | ASTM C266 | 01:10 |
| Final Set, hrs:min | ASTM C266 | 04:35 |
| 1 day Compressive str. psi | ASTM C109M | 4550 |

### Example 4

A mortar composition useful for low pressure spray applied vertical and overhead applications was prepared using a two-component kit comprising separately packaged pre-proportioned cementitious powder and liquid additive components.

Powder Component: base mortar

| Liquid Component | % |
|---|---|
| Water | 92.63 |
| Modified clay | .30 |
| Modified cellulose ether | 0.07 |
| Glycol Ether | 7.00 |
| | 100.00 |

| Mix Parameters | Test Methods | Results |
|---|---|---|
| Powder | | 1 kg |
| Liquid | | 0.14 kg |
| Flow @ 10 drops | ASTM C230 | 40 |
| Unit Wt. lbs/ft3 | ASTM C185 | 140 |
| Stiffening Rate, hrs:min | ASTM C266 | 00:27 |
| Initial Set, hrs:min | ASTM C266 | 00:48 |
| Final Set, hrs:min | ASTM C266 | 04:51 |
| 1 day Compressive str. psi | ASTM C109M | 4975 |

### Example 5

A self-consolidating mortar composition for both form and pour and form and pump applications was prepared using a two-component kit comprising separately packaged pre-proportioned cementitious powder and liquid additive components.

Powder Component: base mortar

| Liquid Component | % |
|---|---|
| Water | 90.85 |
| Cement Dispersant | 1.60 |
| Modified Cellulose Ether | 0.40 |
| Defoamer | 0.65 |
| Glycol Ether | 6.50 |
| | 100.00 |

| Mix Parameters | Test Methods | Results |
|---|---|---|
| Base Mortar | | 1 kg |
| Liquid | | 0.154 kg |
| Flow, inches | ASTM C230 | 6.00 |
| Unit Wt. lbs/ft3 | ASTM C185 | 138.4 |
| Stiffening Rate, hrs:min | ASTM C266 | 01:48 |
| Initial Set, hrs:min | ASTM C266 | 02:08 |
| Final Set, hrs:min | ASTM C266 | 05:05 |
| 1 day Compressive str. psi | ASTM C109M | 4200 |

### Example 6

A flexible mortar composition useful for antifracture and watertight membrane applications was prepared using a two-component kit comprising separately packaged pre-proportioned cementitious powder and liquid additive components.

Powder Component: base mortar

| Liquid Component | % |
|---|---|
| Water | 30.60 |
| Aqueous Polymer Dispersion | 66.15 |
| Defoamer | 0.25 |
| Glycol Ether | 3.00 |
| | 100.00 |

| Mix Parameters | Test Methods | Results |
|---|---|---|
| Base Mortar | | 1 kg |
| Liquid | | 0.387 kg |

### Example 7

A reduced shrinkage screedable mortar composition was prepared using a two-component kit comprising separately packaged pre-proportioned cementitious powder and liquid additive components.

Powder Component: base mortar

| Liquid Component | % |
|---|---|
| Water | 92.30 |
| Glycol Ether | 7.70 |
| | 100.00 |

| | | |
|---|---|---|
| Mix Parameters | Test Methods | Results |

| | | |
|---|---|---|
| Base Mortar | 1 | kg. |
| Liquid | 0.13 | kg |

| | | |
|---|---|---|
| Flow @ 10 drops | ASTM C230 | 72 |
| Unit Wt. lbs/ft3 | ASTM C185 | 140 |
| Stiffening Rate, hrs:min | ASTM C266 | 00:48 |
| Initial Set, hrs:min | ASTM C266 | 01:15 |
| Final Set, hrs:min | ASTM C266 | 05:10 |
| 1 day Compressive str. Psi | ASTM C109M | 4325 |
| 7 day Compressive str. Psi | ASTM C109M | 7850 |
| 28 day Compressive str. Psi | ASTM C109M | 10270 |
| 3 day Length change % | ASTM C157M | −0.012 |
| 7 day Length change % | ASTM C157M | −0.024 |
| 28 day Length change % | ASTM C157M | −0.048 |
| Restrained ring-time to | ASTM C1581 | 28 days |
| cracking | | |

ASTM C157 specimens were air cured, a modification to the test.
ASTM C1581 and C109 specimens were moist cured 1 day, also a modification to the standard test method.

### Example 8

A polymer-modified screedable mortar composition was prepared using a two-component kit comprising separately packaged pre-proportioned cementitious powder and liquid additive components.

Powder Component: base mortar

| Liquid Component | % |
|---|---|
| Water | 85.73 |
| Aqueous Polymer Dispersion | 7.10 |
| Defoamer | 0.07 |
| Glycol Ether | 7.10 |
| | 100.00 |

| Mix Parameters | Test Methods | Results |
|---|---|---|
| Base Mortar | | 1 kg. |
| Liquid | | 0.14 kg |
| Flow @ 10 drops | ASTM C230 | 76 |
| Unit Wt. lbs/ft3 | ASTM C185 | 132.4 |
| Stiffening Rate, hrs:min | ASTM C266 | 00:60 |
| Initial Set, hrs:min | ASTM C266 | 01:45 |
| Final Set, hrs:min | ASTM C266 | 03:15 |
| 1 day Compressive str. psi | ASTM C109M | 3900 |
| 7 day Compressive str. psi | ASTM C109M | 5658 |
| 28 day Compressive str. psi | ASTM C109M | 7125 |
| 3 day Length change % | ASTM C157M | −0.012 |
| 7 day Length change % | ASTM C157M | −0.028 |
| 28 day Length change % | ASTM C157M | −0.038 |
| 28 day Flexural strength, psi | ASTM348 | 788 |
| Restrained ring-time to cracking | ASTM C1581 | No cracking 28 days |

ASTM C157, C348, C1581, and C109 specimens were moist cured 1 day, a modification to the standard test method.

### Example 9

A polymer-modified vertical/overhead mortar composition useful for vertical and overhead applications was prepared using a two-component kit comprising separately packaged pre-proportioned cementitious powder and liquid additive components.

Powder Component: base mortar

| Liquid Component | % |
|---|---|
| Water | 86.89 |
| Aqueous Polymer Dispersion | 6.20 |
| Modified clay | 0.25 |
| Starch ether | 0.10 |
| Modified cellulose ether | 0.06 |
| Defoamer | 0.30 |
| Glycol Ether | 6.20 |
| | 100.00 |

| Mix Parameters | Test Methods | Results |
|---|---|---|
| Base Mortar | | 60 lbs. |
| % Liquid | | 16% |
| Flow @ 10 drops | ASTM C230 | 54 |
| Unit Wt. lbs/ft3 | ASTM C185 | 129.6 |
| Stiffening Rate, hrs:min | ASTM C266 | 00:75 |
| Initial Set, hrs:min | ASTM C266 | 02:30 |
| Final Set, hrs:min | ASTM C266 | 03:55 |
| 1 day Compressive str. psi | ASTM C109M | 2773 |
| 7 day Compressive str. psi | ASTM C109M | 5092 |
| 28 day Compressive str. psi | ASTM C109M | 6183 |
| 3 day Length change % | ASTM C157M | −0.025 |
| 7 day Length change % | ASTM C157M | −0.048 |
| 28 day Length change % | ASTM C157M | −0.071 |
| 28 day Flexural strength, psi | ASTM348 | 1062 |
| Restrained ring-time to | ASTM C1581 | No cracking 28 days |
| cracking | | |

ASTM C157, C348, C1581, and C109 specimens were moist cured 1 day, a modification to the standard test method.

### Example 10

A polymer-modified self-consolidating mortar composition was prepared using a two-component kit comprising separately packaged pre-proportioned cementitious powder and liquid additive components.

Powder Component: base mortar

| Liquid Component | % |
|---|---|
| Water | 84.66 |
| Aqueous Polymer Dispersion | 7.10 |
| Cement Dispersant | 0.60 |
| Modified cellulose ether | 0.40 |
| Defoamer | 0.14 |
| Glycol Ether | 7.10 |
| | 100.00 |

| Mix Parameters | Test Methods | Results |
|---|---|---|
| Base Mortar | | 1 Kg |
| Liquid | | 0.14 Kg |
| Flow @ 10 drops | ASTM C230 | 110% |
| Unit Wt. lbs/ft3 | ASTM C185 | 136 |
| Stiffening Rate, hrs:min | ASTM C266 | 01:45 |
| Initial Set, hrs:min | ASTM C266 | 02:55 |
| Final Set, hrs:min | ASTM C266 | 03:55 |
| 1 day Compressive str. psi | ASTM C109M | 4291 |
| 7 day Compressive str. psi | ASTM C109M | 6476 |
| 28 day Compressive str. psi | ASTM C109M | 8353 |
| 3 day Length change % | ASTM C157M | −0.0155 |
| 7 day Length change % | ASTM C157M | −0.033 |
| 28 day Length change % | ASTM C157M | −0.052 |
| 28 day Flexural strength, psi | ASTM348 | 1042 |
| Restrained ring-time to | ASTM C1581 | No cracking 28 days |
| cracking | | |

ASTM C157, C348, C1581, and C109 specimens were moist cured 1 day, a modification to the standard test method.

It will be understood that the various embodiments described herein are merely exemplary, and that one skilled in the art may make variations and modifications without departing from the spirit and scope of the disclosure. All such variations and modifications are intended to be included within the scope hereof. Furthermore, all embodiments disclosed are not necessarily in the alternative, as various embodiments described herein may be combined to provide the desired result. Therefore, the cementitious composition, kit and method should not be limited to any single embodiment, but rather construed in breadth and scope in accordance with the recitation of the attached claims.

We claim:

1. A kit for preparing a hardenable cementitious composition comprising:
a pre-proportioned base cementitious material component that may be mixed with differently formulated liquid additives; and
at least one pre-proportioned and pre-formulated liquid additive component.

2. The kit of claim 1, wherein said base cementitious material and liquid additive components are separately packaged in non-reclosable containers.

3. The kit of claim 2, wherein said separately packaged cementitious material and liquid additive components are contained within an overpack container.

4. The kit of claim 1, wherein said cementitious component is selected from the group of consisting of Portland cement, modified Portland cement, masonry cement, alumina cement, refractory cement, magnesium phosphate cement, magnesium potassium phosphate cement, calcium aluminate cement, calcium sulfoaluminate cement, calcium sulfate hemi-hydrate cement, oil well cement, ground granulated blast furnace slag cement, natural cement, hydraulic hydrated lime, and mixtures of these materials.

5. The kit of claim 4, wherein said cementitious material comprises Portland cement.

6. The kit of claim 1, wherein said liquid additive component comprises water and other additives selected from the group consisting of aqueous polymer dispersions, thickening agents, cement dispersants, density modifiers, rheology modifiers, defoamers, shrinkage reducing admixtures, pigment dispersions, preservatives and combinations of there materials.

7. The kit of claim 1, further comprising a separately packaged aggregate addition.

8. The kit of claim 7, wherein said separately packaged aggregate addition comprises fine aggregate, coarse aggregate or a combination of fine and coarse aggregate.

9. The kit of claim 1, wherein said packaged base cementitious material component further comprises an aggregate addition.

10. The kit of claim 9, wherein said aggregate addition comprises fine aggregate, coarse aggregate or a combination of fine and coarse aggregate.

11. The kit of claim 1, wherein said base cementitious material component further comprises an aggregate addition and wherein said kit further comprises a separately packaged aggregate addition.

12. The kit of claim 11, wherein said separately packaged aggregate addition or said aggregate addition in the packaged base cementitious material component independently comprises fine aggregate, coarse aggregate or a combination of fine and coarse aggregate.

13. The kit of claim 7, wherein said separately packaged aggregate addition further comprises fibers.

14. The kit of claim 13, where said fibers are selected from the group consisting of carbon, ceramic, glass, metal, metal alloy, polymer and combinations thereof.

15. The kit of claim 1, wherein said packaged base cementitious material component further comprises a fiber addition.

16. The kit of claim 15, where said fibers are selected from the group consisting of carbon, ceramic, glass, metal, metal alloy, polymer and combinations thereof.

17. A method for preparing a hardenable cementitious composition comprising mixing together a pre-proportioned base cementitious material component and a pre-formulated and pre-proportioned liquid component, wherein said composition comprises end application dictated performance characteristics that are imparted by said liquid component.

18. The method of claim 17, wherein said mixing comprises mixing said pre-proportioned base cementitious material component and said liquid additive component at a ratio of 1:1.

19. The method of claim 17, wherein said pre-proportioned base cementitious material component and said liquid additive component are provided in separate non-reclosable containers, and wherein said mixing comprises mixing 1 container of said pre-proportioned cementitious component with 1 container of said pre-formulated and pre-proportioned liquid additive component.

20. The method of claim 17, wherein said hardenable cementitious composition comprises a hardenable cementitious binder paste.

21. The method of claim 17, wherein said hardenable cementitious composition comprises a hardenable mortar.

22. The method of claim 17, wherein said hardenable cementitious composition comprises a hardenable concrete.

23. A method for repairing a flaw in a cementitious structure comprising:
mixing together a pre-proportioned base cementitious material component and a pre-formulated and pre-proportioned liquid additive component to form a hardenable cementitious repair composition having end application dictated performance characteristics imparted by the liquid component; and
applying said cementitious repair composition to said flaw.

24. The method of claim 23, wherein said mixing comprises mixing said pre-proportioned base cementitious material component and said liquid additive component at a ratio of 1:1.

25. The method of claim 23, wherein said pre-proportioned base cementitious material component and said liquid additive component are provided in separate non-reclosable containers, and wherein said mixing comprises mixing 1 container of said pre-proportioned cementitious component with 1 container of said pre-formulated and pre-proportioned liquid additive component.
